(19) United States
(12) Patent Application Publication
(10) Pub. No.: US 2003/0188308 A1
(43) Pub. Date: Oct. 2, 2003

(54) Advertisement inserting method and system is applied the method

(75) Inventor: Yoshihisa Kizuka, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/394,209

(22) Filed: Mar. 24, 2003

(30) Foreign Application Priority Data
Mar. 27, 2002 (JP) 2002-089953

(51) Int. Cl. H04N 7/10; H04N 7/025

(52) U.S. Cl. 725/32; 725/36; 725/105

(57) ABSTRACT

The present invention is applied to a system in which a distributing side has a video contents storing apparatus, an advertising contents storing apparatus, and a transmitting apparatus, and a viewing side has a set top box. When advertising contents are inserted into video contents, the video contents and the advertising contents are respectively and independently managed at a distributing side, and the advertising contents are selectively inserted into the video contents at the distributing side and the viewing side.

### CROSS-REFERENCE TO RELATED APPLICATIONS

This application is based upon and claims the benefit of priority from the prior Japanese Patent Application No. 2002-089953, filed Mar. 27, 2002, the entire contents of which are incorporated herein by reference.

### BACKGROUND OF THE INVENTION

1. Field of the Invention

The present invention relates to a technique for inserting advertising contents into a television broadcast or the like, and in particular, to an advertisement inserting method, a distributing system, a transmitting apparatus, a receiving apparatus, and a program product.

2. Description of the Related Art

Advertising contents (television commercials) in a conventional television broadcast are basically distributed as a simultaneous broadcast, and all of the viewers usually receive the same advertising contents. It has been extremely difficult to insert advertising contents matching the intentions of sponsors, contents providers, and distributors, from the standpoint of the technical aspects.

Further, recently, a system in which a database of the preferences of the viewers is prepared by researching by questionnaires or the like and commercials matching the viewer preference information or the like are inserted in accordance with the database by the broadcasting station side in digital broadcasts or broadcasts using a broadband infrastructure or in a streaming distribution, have been embodied.

This system is a service in which advertising contents matching the registered information of a sponsor, a contents provider, and a viewer are selected and inserted into the video content which are streaming-distributed on an internet by the distributing server side, and currently, the field validation is being carried out.

In such an advertisement, there are following merits for the sponsors, the contents providers, and the viewers.

(Merits for Sponsors)

(1) It is possible to insert advertising contents into the streaming video contents on the basis of the viewer information.

(2) Because advertisements are inserted on the basis of the viewer information, it is possible to predatorily advertise to the viewers having interests.

(3) An accounting system by the number of appearance corresponding to the viewed amount of the advertising contents can be used.

(4) It is possible to research an advertisement viewing state in detail.

(Merits for Contents Providers and Content Distributors)

(1) The burden on the advertising operations is reduced.

(2) It is possible to insert the advertising contents by designating a point at which an advertisement is inserted.

(3) The viewing fees of the contents can be diversified in accordance with the inserted amount of the advertisements.

(4) Movement of the viewers can be verified by distribution reports.

(Merits of Viewers)

(1) Because it is possible to insert the advertising contents matching the contents by registering the individual attribute, hobbies, and preference information in advance, interesting advertising contents can be viewed along with the video contents.

(2) Due to the viewing fees of the contents being diversified in accordance with the inserted amount of the advertisements, the options of the viewing fees of the same contents increase.

With respect to the techniques relating to a method for flexibly inserting advertising contents into video contents in accordance with individual preference information, there are the above-mentioned advantages in the conventional art described above. However, the following problems which must be improved can be listed.

(1) In a case of video simultaneous distribution to the general public, the insertion of an advertisement matching the individual preferences and attributes cannot be carried out. Namely, not in the cases of distributing to individual viewers such as VOD (Video On Demand) or video distribution for some specific viewers such as a video distributing system of a multicast in units of groups, but in the case of broadcast service (broadcast distribution) which does not specify the viewers which is the general format of present telecasts, if the place in which the advertisement insertion is executed is the broadcasting station side, advertisement insertion matching the individual preference information cannot be realized.

(2) Replacement of an advertisement when the video contents moves among the viewers cannot carried out. Namely, with respect to contents into which advertising contents are inserted in accordance with the preference information of the specific viewers, it can be thought that an extremely high effect of advertising can be obtained for the specific viewers. However, from the standpoint of reusing the contents, for example, when the same contents are shown to another viewer by copying or moving the contents including the advertising contents, it can be easily anticipated that there will be an increase in cases in which the effects of the advertising deteriorate. In such a case, for example, when the viewer is changed, replacement of the advertising contents has not been considered.

(3) The freshness of the advertising contents in the contents after a uniform period of time has passed due to the contents recording or the like deteriorates. Namely, the advertising contents have a term of validity which is for notifying the commercial products to be advertised to the viewers, and the freshness thereof is an extremely important factor. If video contents including advertising contents which have been recorded are left once for a period of time after the recording, at the time of reviewing the contents, the freshness of the advertisement deteriorates due to the appearance of new products or the like, and merits for the sponsor are reduced.

### BRIEF SUMMARY OF THE INVENTION

An object of the present invention is to provide an advertisement inserting method, a system to which the method is applied, apparatuses, and a program products, in which sponsors, contents providers, content distributors, and viewers can respectively have more merits.

In order to achieve the above object, according to an aspect of the present invention, there is provided an advertisement inserting method which is applied to a system in which a distributing side has at least a storing apparatus configured to store video contents and advertising contents and a transmitting apparatus, and a viewing side has at least a viewing apparatus configured to view the video contents in which the advertising contents are inserted, the method inserting the advertising contents into the video contents,

wherein the video contents and the advertising contents are respectively and independently managed at the distributing side, and the advertising contents are selectively inserted into the video contents at the distributing side and the viewing side.

In order to achieve the above object, according to another aspect of the present invention, there is provided a distributing system comprising:

a transmitting apparatus comprising a classification managing unit configured to individually manage video contents and advertising contents and to classify and manage the advertising contents at least on the basis of characteristics which do not relate to characteristics of a viewing side and characteristics which relate to characteristics of the viewing side, a transmitting unit configured to transmit the advertising contents classified on the basis of the characteristics which relate to the characteristics of the viewing side to the viewing side so as to be inserted in the video contents at the viewing side, and to insert the advertising contents classified on the basis of the characteristics which do not relate to the characteristics of the viewing side into the video contents so as to transmit them to the viewing side, and a transmitting side holding unit configured to hold contents meta information showing an outline of the video contents; and

a receiving apparatus comprising a receiving side holding unit configured to hold the advertising contents classified on the basis of the characteristics which relate to the characteristics of the viewing side, and an interposing unit configured to make at least one of the advertising contents of the holding unit and advertising contents downloaded from the distributing side be interposed into the video contents with reference to the contents meta information.

In order to achieve the above object, according to another aspect of the present invention, there is provided a transmitting apparatus comprising:

a classifying managing unit configured to individually manage video contents and advertising contents, and to classify and manage the advertising contents at least on the basis of characteristics which do not relate to characteristics of a viewing side and characteristics which relate to characteristics of the viewing side; and

a transmitting unit configured to transmit the advertising contents classified on the basis of the characteristics which relate to the characteristics of the viewing side to the viewing side so as to be inserted in the video contents at the viewing side, and to insert the advertising contents classified on the basis of the characteristics which do not relate to the characteristics of the viewing side into the video contents so as to transmit them to the viewing side.

In order to achieve the above object, according to another aspect of the present invention, there is provided a transmitting program stored in a computer readable medium configured to distribute video contents into which advertising contents are inserted to a viewing side, the transmitting program comprising:

individually managing video contents and advertising contents, and classifying and managing the advertising contents at least on the basis of characteristics which do not relate to characteristics of the viewing side and characteristics which relate to the characteristics of the viewing side;

transmitting the advertising contents classified on the basis of the characteristics which relate to the characteristics of the viewing side to the viewing side so as to be inserted into the video contents at the viewing side;

inserting the advertising contents classified on the basis of the characteristics which do not relate to the characteristics of the viewing side into the video contents, and transmitting them it to the viewing side;

holding contents meta information showing an outline of the video contents; and

transmitting to the viewing side advertising contents insertion conditions corresponding to the video contents by referring to the contents meta information from the viewing side.

In order to achieve the above object, according to another aspect of the present invention, there is provided a receiving apparatus receiving, from a distributing side, video contents into which advertising contents to be displayed on a display device are inserted, comprising:

a holding unit configured to hold the advertising contents; and

an interposing unit configured to make at least one of the advertising contents of the holding unit and advertising contents downloaded from the distributing side be interposed into the video contents, with reference to contents meta information showing an outline of the video contents provided at the distributing side.

In order to achieve the above object, according to another aspect of the present invention, there is provided a receiving program stored in a computer readable medium having a function of receiving, from a distributing side, video contents into which advertising contents to be displayed on a display device are inserted, the receiving program comprising:

holding advertising contents; and

making at least one of the held advertising contents and advertising contents downloaded from the distributing side be interposed into the video contents, with reference to contents meta information showing an outline of the video contents provided at the distributing side.

In accordance with the advertisement inserting method of the present invention, because the video contents and the advertising contents are respectively and independently managed and the advertising contents are selectively inserted into the video contents at the distributing side and the viewing side, even if the same video contents are simultaneously broadcast-distributed, advertising contents which are different for each viewer can be presented.

In accordance with the distributing system of the present invention, the video contents and the advertising contents are individually managed, and advertising contents, which are classified on the basis of the characteristics which do not relate to the characteristics at the viewers side are inserted, into the video contents at the distributing side, and advertising contents, which are classified on the basis of the characteristics which relate to the characteristics at the viewers side, are inserted into the video contents at the viewing side. In this way, even if the same video contents are simultaneously broadcast-distributed, advertising contents which are different for each viewer can be presented. Further, when the video contents are reviewed at the viewing side, or the like, by referring to the contents meta information, the advertising contents, which are classified on the basis of the characteristics which relate to the characteristics at the viewers side at that point in time, can be replaced and inserted into the video contents, and advertising contents matching the viewing side can be presented even if it is reviewing or the like.

In accordance with the transmitting apparatus and the transmitting program of the present invention, the video contents and the advertising contents are individually managed, and advertising contents, which are classified on the basis of the characteristics which do not relate to the characteristics at the viewing side, are inserted into the video contents at the distributing side, and advertising contents, which are classified on the basis of characteristics which relate to the characteristics at the viewing side, are inserted into the video contents at the viewing side. In this way, if the same video contents are simultaneously broadcast-distributed, advertising contents which are different for each viewer can be presented.

In accordance with the transmitting apparatus and the receiving program of the present invention, due to at least one of the advertising contents of the holding unit and the advertising contents downloaded from the distributing side being interposed in the video contents by referring to the contents meta information showing the outline of the video contents provided at the distributing side, if the distributing side simultaneously broadcast-distributes the same video contents, advertising contents which are different for each viewer can be presented.

### BRIEF DESCRIPTION OF THE SEVERAL VIEWS OF THE DRAWING

FIG. 1 is a block diagram showing a contents distributing system according to an embodiment of the present invention.

FIG. 2 is a flowchart showing procedures for inserting advertising contents for video contents in the embodiment.

FIG. 3 is a view showing types of advertisements in the embodiment.

FIG. 4 is a view showing preference information of viewers in the embodiment.

FIG. 5 is a view showing viewer's attributes in the embodiment.

FIG. 6 is a view showing the video contents and the inserting points of the advertising contents in the embodiment.

FIG. 7 is a view showing information of positions at which advertising contents can be inserted in the embodiment.

FIG. 8 is a view showing examples of the information of the advertising contents to be inserted in the embodiment.

FIG. 9 is a view showing target advertisement managing data in the embodiment.

FIG. 10 is a view showing the preference information in the embodiment.

FIG. 11 is a view showing the attribute information in the embodiment.

FIG. 12 is a flowchart showing operations of a video playback software in a set top box in the embodiment.

FIG. 13 is a view showing an electronic guiding screen in the embodiment.

FIG. 14 is a sequence diagram showing operations of the first usage of the video contents in the embodiment.

FIG. 15 is a flowchart showing operations of the video playback software in the set top box at the time of reusing videos in the embodiment.

FIG. 16 is a flowchart showing operations of the video playback software in the set top box at the time of reusing the video contents in the embodiment.

FIG. 17 is a sequence diagram showing operations of re-usage of the video contents in the embodiment.

### DETAILED DESCRIPTION OF THE INVENTION

Hereinafter, an embodiment according to the present invention will be described with reference to the drawings.

(Structure of the System)

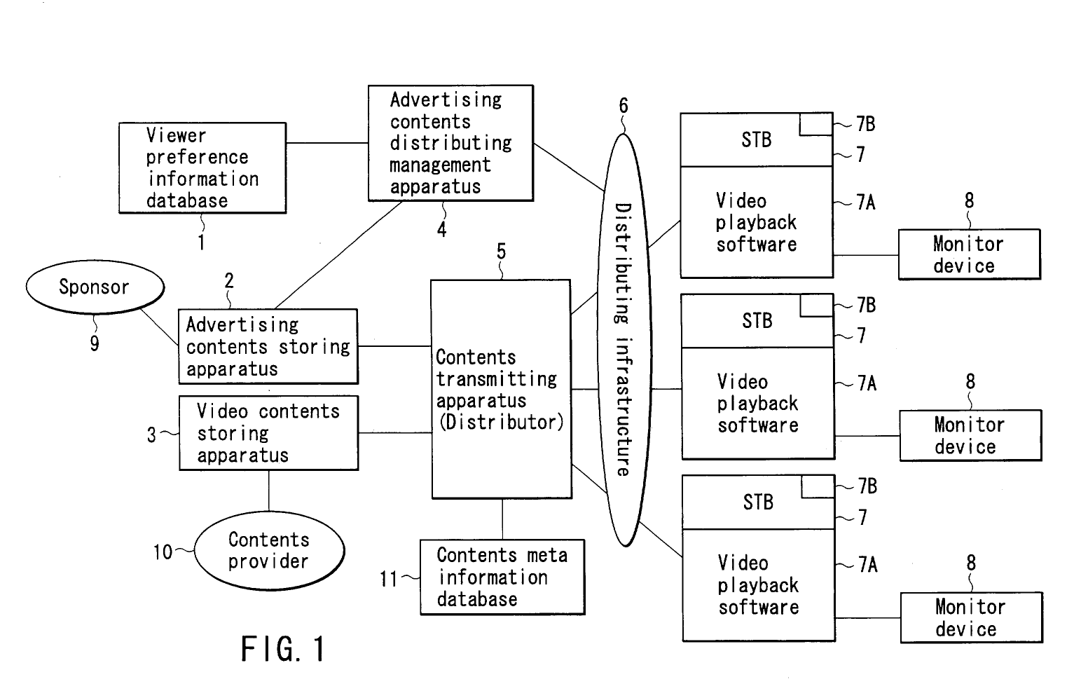

FIG. 1 shows a distributing system according to the present embodiment, and in a viewer preference information database 1, the preference information of viewers is made into a database. As the unit of the preference information collection, the preference information can be collected by a questionnaire format by a distributor.

In an advertising contents storing apparatus 2, advertising contents provided by a sponsor 9 are stored.

In a video contents storing apparatus 3, the video contents provided by a contents provider 10 are stored.

An advertising contents distributing management apparatus 4 leads out the advertising contents (a target advertisement) corresponding to the preference information and the attribution information for each viewer, and distributes and manages the advertising contents. Further, when the advertising contents are requested by a set top box (STB) 7, the advertising contents are distributed by using the advertising contents storing apparatus 2. Also, information expressing to what extent the advertising contents have been viewed are collected from the respective set top boxes 7, and are managed.

A contents transmitting apparatus 5, which the content distributor has, is usually in a broadcasting system. The contents transmitting apparatus 5 distributes the video contents all at once with respect to the requests from the viewers or the general public viewers. However, at this time, at a point (advertisement inserting position) determined by a contents provider 10, the advertising contents are read in accordance with the information of contents meta information maintained in a contents meta information database 11, and an advertisement is inserted and distributed.

As an infrastructure 6 for use in distribution, an infrastructure such as a cable television infrastructure, an internet infrastructure, and the like which can communicate in two ways is supposed.

The set top box 7 receives the video contents, into which the advertising contents are inserted and which are displayed on a monitor device 8, from the transmitting apparatus 5, and has a video playback software 7A and a hard disk drive (HDD) 7B. Advertisements matching the preference and attribution information of the viewers are distributed and stored in advance into the hard disk drive 7B. In this way, at the time of inserting the advertisement at the client side, the advertisement is inserted and played back by the video playback software 7A.

The video/audio from the set top box 7 is inputted to and displayed on the monitor device 8 such as a TV or the like.

The sponsor 9 provides the produced advertising contents to a distributor or a contents provider.

The contents provider 10 provides the video contents to a distributing system dealer via the video contents storing apparatus 3. At this time, the contents provider 10 provides the contents meta information including information regarding what point of the video contents the advertisement must be inserted into, and the contents meta information is stored in the contents meta information database 11.

In the contents meta information database 11, attributes of the video contents, for example, data such as a content ID, a title, a producer, a copyright information, the cast, a genre, or the like are registered for each content. Information of positions into which the video contents can be inserted is included in the registered information.

(Basic Operation of System)

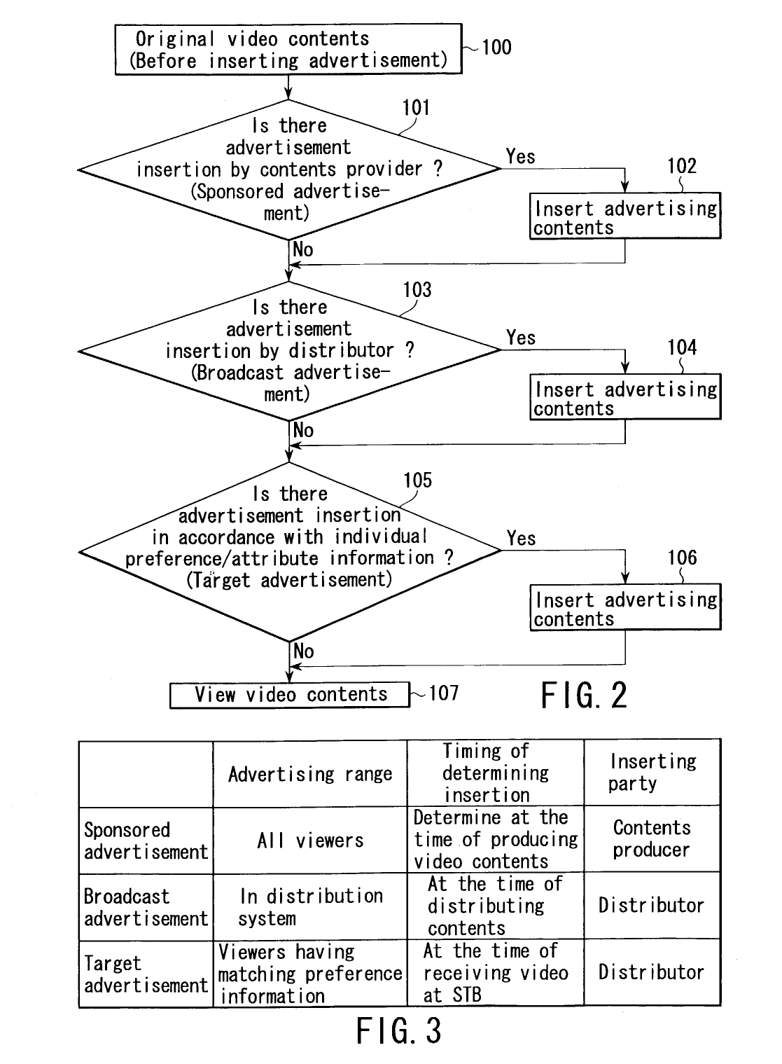

In the present embodiment, the advertising contents are inserted into the video contents in accordance with the flow shown in FIG. 2. Namely, processings for determining the presence/absence of the insertion of an advertisement by a contents provider (sponsored advertisement) (101), the presence/absence of the insertion of an advertisement by a distributor (broadcast advertisement) (103), and the presence/absence of the insertion of an advertisement by individual preference/attribution information (sponsored advertisement) (105) are carried out for original video contents before the advertising contents are inserted. In cases in which the respective determinations are “presence”, the respective contents are inserted into the original video contents 100 (102, 104, 106), and the video contents into which the contents have been inserted are viewed by the respective viewers (107).

The outline of the three types of advertisements described above is as follows.

(1) Sponsored Advertisement

A sponsored advertisement is defined as advertising contents in which the connection between the video contents and the advertising contents are extremely strong. Namely, a case can be supposed in which insertion of given advertising contents into the video contents is obligatory due to production funds being provided by a sponsor. In this way, when the video contents and the advertising contents have an extremely strong connection, the inserted advertising contents are basically used so as to be one portion of the video contents.

(2) Broadcast Advertisement

A broadcast advertisement is defined as advertising contents which a distributor inserts at the time of distributing the video contents. Namely, it is an advertisement inserting method which is used when the inserted image distributor fixedly inserts the advertising contents into some contents. In this case, the inserted advertising contents are distributed to all of the viewers of the range where the distributor distributes. Differently from the sponsored advertisement, even if it is the same video contents, the advertisement can be replaced by the distributor. Further, if the distributor is changed, the advertisement which will be inserted can be changed.

(3) Target Advertisement

A target advertisement is defined as advertising contents for individuals which are selected in accordance with the preference/attribution information of the viewers. Namely, the target advertisement is advertising contents distributed in accordance with information such as an individual preferences and attributes, or the like. The advertising contents are classified into genres in accordance with the preferences, and advertising contents matching the individual preferences and attributes are inserted. In this case, the objects of distribution are only the viewers who match the preference/attribution information. This is a unit which predatorily advertises to the viewers on which the effects of advertising is high.

Note that the differences between the sponsored advertisement, the broadcast advertisement, and the target advertisement described above are shown in FIG. 3.

(Method for Organizing Database and Advertisement Inserting Method)

First, a method for organizing a database and an advertisement inserting method which are necessary for system operation will be described.

(1) Making Viewer Preference Information and Viewer Attribute into Storage Database

The preferences and the attributes of viewers are acquired by researching by questionnaires, and are made to be a database.

At the time of making a database, IDs are allocated to the respective viewers, and after the preferences are classified into genres, the degree of interest for each genre is researched by a questionnaire. The degree of interest is acquired by letting the viewers reply to the questionnaire in accordance with the degree of interest, for example, by 5 degrees evaluation.

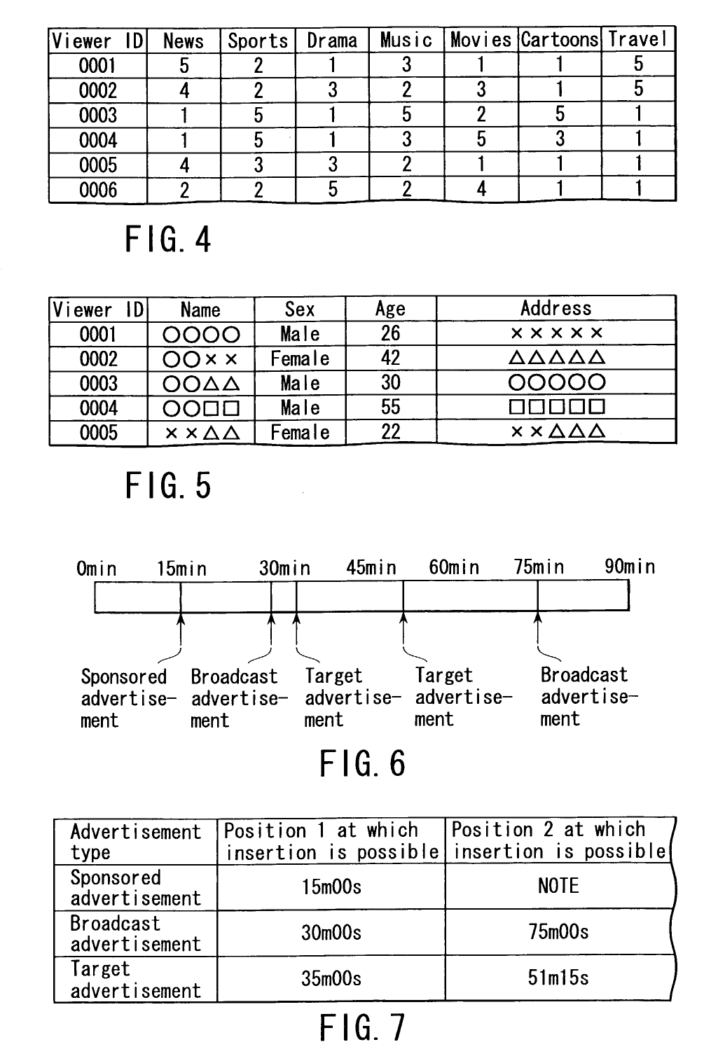

In the case of FIG. 4 showing one example of the preference information, the viewer whose viewer ID is 0001 has extreme interests in news and travel, and has some interest in music and sports. On the other hand, it can be inferred that the viewer does not have much interest in dramas and cartoons.

The attribute information of the viewers are made to be a database in the same way as the preference information described above. The database includes, as the viewer ID serving as a key, the attribute data such as name, sex, age, address, or the like, and for example, they are shown as in FIG. 5.

(2) Storage of Video Contents, Storage of Advertising Contents, and Preparation of Contents Meta Information

The video contents are collected into the video contents storing apparatus 3 as digital data via a tape medium or a network from the contents provider 10. In the video contents storing apparatus 3, the video contents are changed into digital data in a format which can be handled by the system, and are stored. With respect to the advertising contents, the sponsor 9 or an advertisement production company who is requested by the sponsor 9 prepares the advertising contents as digital data, and stores the advertising contents in the advertising contents storing apparatus 2.

In order for the video contents and the advertising contents to be able to be distributed, it is necessary for the contents meta information to be registered into the contents meta information database 11.

The information which are registered are such as the following.

Examples of attribute data to be included in the contents meta information

Content ID

Title

Genre

Produced month and date

Viewing expiration date

Broadcasting date, time

Outline description

Cast

Creator Producer

A content ID which is an ID for uniquely handling the video contents (including the advertising contents) in a system is allocated to the contents. Title expresses the title of the video contents, and Genre expresses the classification of the contents such as news, sports, and dramas. Produced month and date expresses the produced date of the contents, and Broadcasting date, time expresses viewable date and time. Outline description expresses the outline of the contents, and Cast information, Creator and Producer information follow. Viewing expiration date shows the final date when the contents are viewable. Particularly, when the contents are advertising contents, the Viewing expiration date is the final date when advertising is possible.

One example is as follows.

Contents meta information

| | |
|---|---|
| Content ID | 0000000200 |
| Title | “□ □ □ □” |
| Genre | News |
| Produced month and date | Jan. 31, 2001 |
| Viewing expiration date | Mar. 03, 2001 |
| Broadcasting date, time | Dec. 01, 2001 12:00-13:00 |
| Outline description | Δ Δ Δ Δ |
| Cast | ◯ ◯ X X |
| Creator Producer | X X X X |

Moreover, in the present embodiment, the following information relating to the advertising contents is included in the contents meta information.

These information can be basically omitted in the case of advertising contents.

A position at which advertising contents can be inserted

A position at which advertising contents can be inserted, and content ID of the advertising contents to be inserted.

Next, an example of the timing at which the advertising contents are inserted into one video content will be described with reference to FIG. 6 and FIG. 7.

FIG. 6 makes one video content be a model. The drawing shows a video of 90 minutes in total, and is a model in which a sponsored advertisement is inserted 15 minutes after the start, and broadcast advertising contents and advertising contents for an individual are inserted 30 minutes after and 75 minutes after, and target advertising contents are inserted 35 minutes after and 50 minutes after.

The information regarding positions at which advertising contents can be inserted, with respect to the video contents of the case of FIG. 6, is as FIG. 7. Namely, in the video contents provided by a contents provider, the position at which the advertising contents can be inserted is determined by the intention or the like of the contents provider who considered the contents matter or the like. A point possible for insertion of the advertising contents expresses the playback time from the start of the video contents (original contents) in a state in which advertisements are not included, to the point for starting insertion. The position for inserting advertising contents which are inserted into one content is determined.

The information regarding positions where insertion is possible are registered by the number of the possible positions for each of three types of advertisements.

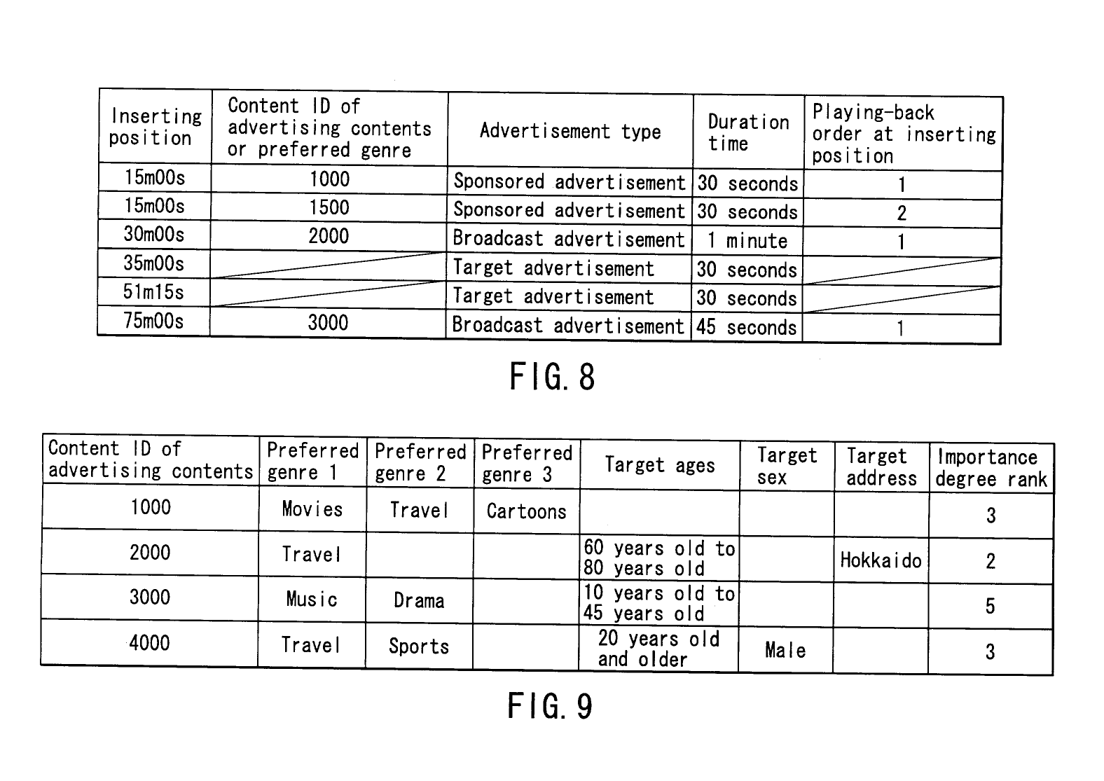

Moreover, examples of the information of the inserting positions of the advertising contents in FIG. 6 and FIG. 7 and the content IDs of the advertising contents to be inserted are as in FIG. 8.

In FIG. 8, the duration time expresses the length of the advertising contents. Namely, in a case of these contents, the total content time including the advertising contents is 93 minutes and 45 seconds because the original video contents are 90 minutes and the adverting contents are 3 minutes and 45 seconds.

There are two positions for inserting which are 15 m 00 s. However, this shows that two advertising contents are inserted at this point, and the playing-back order shows that the advertisement whose playing-back order is higher, i.e., in the above-described case, the advertisement whose content ID is 100, is inserted, and the advertisement whose ID is 1500 is inserted so as to follow it.

With respect to the sponsored advertising contents and the broadcast advertising contents, information regarding which advertising contents are to be inserted is registered at this point in time. However, with respect to the target advertisement, which advertisement is to be inserted is not determined, in the contents meta information. The method for selecting the target advertisements will be described later.

When the distributor distributes these contents, the contents into which the sponsored advertisement and the broadcast advertisement are inserted are distributed. At the time zone when the target advertisement must be inserted, a dummy video is distributed.

(3) Method for Selecting Target Advertisements

As shown in (2),with respect to the target advertisement, information regarding which advertising contents are to be inserted is not included in the contents meta information. With respect to the target advertisement, in order to insert an advertisement matching the preferences and the attributes of the viewers, the database as shown in FIG. 9 is managed, and the database is used for the selection of the advertisements to be inserted. The advertising contents registered in the database are all of the advertising contents which can be used for the target advertisements. Advertisements used as broadcast advertisements and the sponsored advertisements are included in these advertisements, and advertising contents dedicated for target advertisements also exist. This information is managed by the advertising contents distributing management apparatus 4.

In FIG. 9, three preferred genres of a viewer to which an advertisement is to be directed, and the age of the viewer, and the sex, and the address are registered for each content ID of the respective advertising contents. The rank of the importance degree expresses the importance degree with respect to the advertisement by a sponsor. For example, the rank of the importance degree can be used such that the rank of the importance degree of the advertisement of a sponsor who paid a large amount of money is raised.

In the above description, an advertisement whose content ID is 1000 is advertising contents for viewers having preferences for movies, travel, and cartoons. The advertisement whose content ID is 3000 is for viewers having preferences for music and dramas, and the target ages thereof are 10 through 45 years old, and is advertising contents whose importance degree is extremely high.

When the target advertising managing database as described above is provided, selection of an advertisement to be inserted into a video can be carried out as follows.

This is one example of the processing carried out by the advertisement distributing management apparatus.

### EXAMPLE

### Selection of Target Advertisement

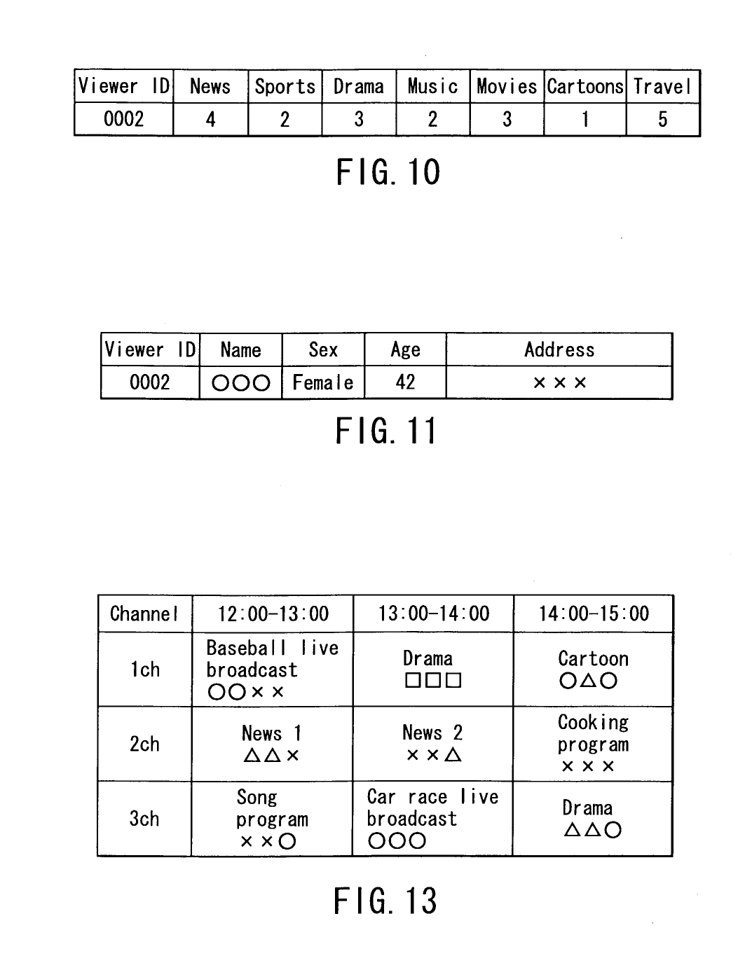

The preference information and the attribute information of the viewers who are the distribution destination are shown in FIG. 10 and FIG. 11.

First, target advertisements, in which the target age, the sex, and the address of the advertisement do not match the viewers, are removed from consideration as objects. In the above-described example, the advertisements whose ID is 2000 (do not match the ages and the address) and 4000 (do not match the sex) are removed from consideration as objects.

Next, among the remaining advertising contents, given that the genre of the preferred genre 1 of the managing database is 5 points, the genre of the preferred genre 2 is 2 points, and the genre of the preferred genre 3 is 1 point, a value, which is obtained by these points and the points of the genres in accordance with the preference information of the viewer being respectively multiplied and added, is the preference degree of the object viewer of the advertising contents.

In the above-described example, the calculation is carried out as follows.

Content ID 1000

5 points (Preferred genre 1: Movies)×3 points (Viewer preference degree of Movies)+2 points (Preferred genre 2: Travel)×5 points (Viewer preference degree of Travel)+1 point (Preferred genre 3: Cartoons)×1 point (Viewer preference degree of Cartoons)=26 points (Preference degree)

Content ID 3000

5 points (Preferred genre 1: Music)×2 points (Viewer preference degree of Music)+2 points (Preferred genre 2: Dramas)×3 points (Viewer preference degree of Dramas)=16 points (Preference degree)

In this way, if calculations are carried out with respect to all of the target advertisements, the advertisement preference degree for the viewer can be ranked. In the above description, it can be understood that the effects of advertising when the advertisement whose content ID is 1000 is inserted can be expected more than when the advertisement whose content ID is 3000 is inserted.

With respect to the actual insertion, the coefficient of the importance degree rank of the advertisement can be added to the preference degree by changing the importance degree rank in accordance with the rate setting at the time of contracting to put in the target advertisement, or the like, in accordance with the intention of the sponsor. Further, if calculation of the preference degree is carried out with the coefficient of the genre being raised two times or the like by using the genre information in the contents meta information of the video contents, the preference degree of the target advertisement matching the preference information of the viewer, among the target advertisements matching the video contents, can be raised.

When a plurality of target advertisements are inserted into the same video contents, it is sufficient to select the target advertisement from the higher rank of the points of the preference degree. Further, when the preference degrees have the same points, the target advertisement can be selected at random, or can be selected by using the importance degree rank or the like. Moreover, in order to prevent a viewer from receiving only the same advertisement, distribution of the advertisements can be diffused or circulated among the advertisements whose preference degrees are of the higher ranks.

(4) Push-Distribution of Set Top Box 7 of Individual Target Advertising Contents

The target advertisement is basically inserted into the contents when the preference information of the viewer and the target advertisements match one another. However, in accordance therewith, it is possible to read only the target advertisement in advance and store it into the set top box 7 at which the hard disk drive 7B is provided.

For example, the points of the preference degrees are calculated for all of the target advertisements for a viewer, and the highest 20 ranks are stored in the set top box 7 from the advertising contents storing apparatus 2. In this processing, a processing for selecting an advertisement is carried out by the advertising contents distributing management apparatus 4, and the selected advertisement is distributed to the hard disk drive 7B of the set top box 7 from the advertising contents storing apparatus 2.

In accordance therewith, processing for inserting an advertisement at the time of distributing, and in particular, at the server side, is reduced. With respect to the target advertisement, after leaving it for a uniform period (one day, one week, one month, or the like), recalculation of the preference degree is carried out, and replacement or the like of the stored advertisements is carried out. Further, the advertisements whose terms of validity have expired are removed from consideration as objects.

The calculation of the preference degree and the information expressing which target advertisement is to be inserted to which viewer, are managed by the advertising contents distributing management apparatus. The sponsor and the distributor can acquire the information expressing which advertisement is to be distributed to what extent to the viewer.

Here, the steps of inserting an advertisement in the system will be described anew.

(1) Determining of Positions at which Advertisements Can Be Inserted

The advertisement insertion position and the type of the advertisement to be inserted are determined as information regarding positions at which advertising contents can be inserted in accordance with the intention of the contents provider and the intention of the distributor, and the information is registered into the contents meta information database.

(2) Insertion of Sponsored Advertisement

Sponsored advertisement inserting registration processing is carried out. This is registered as the advertising content information of the video contents in the contents meta information database 11 in accordance with the intention of the sponsor or the contents provider.

The distributor inserts the sponsored advertisement at an appropriate time during the time of distribution and distributes it with reference to the contents meta information.

(3) Insertion of Broadcast Advertisement

Broadcast advertisement registration processing is carried out as the advertising contents information of the video contents in the contents meta information database 11 by the distributor.

The distributor inserts the broadcast advertisement at an appropriate time during the distributing time and distributes it with reference to the contents meta information.

(4) Insertion of Target Advertisement at the Client Side of the System Side

When the distributor distributes the contents of a video into which a target advertisement must be inserted, the distributor transmits a dummy video during the time of inserting the target advertisement. During the time the dummy video is being distributed, the target advertisement is inserted by the set top box 7 which is the client side system, and the viewer cannot determine that the dummy video has been switched to the target advertisement at the client side.

This will be described later as the operation of the client side system.

(Operation of Set Top Box 7)

The target advertisement inserting processing at the set top box 7 which is the client side of the distributing system of the present embodiment will be described.

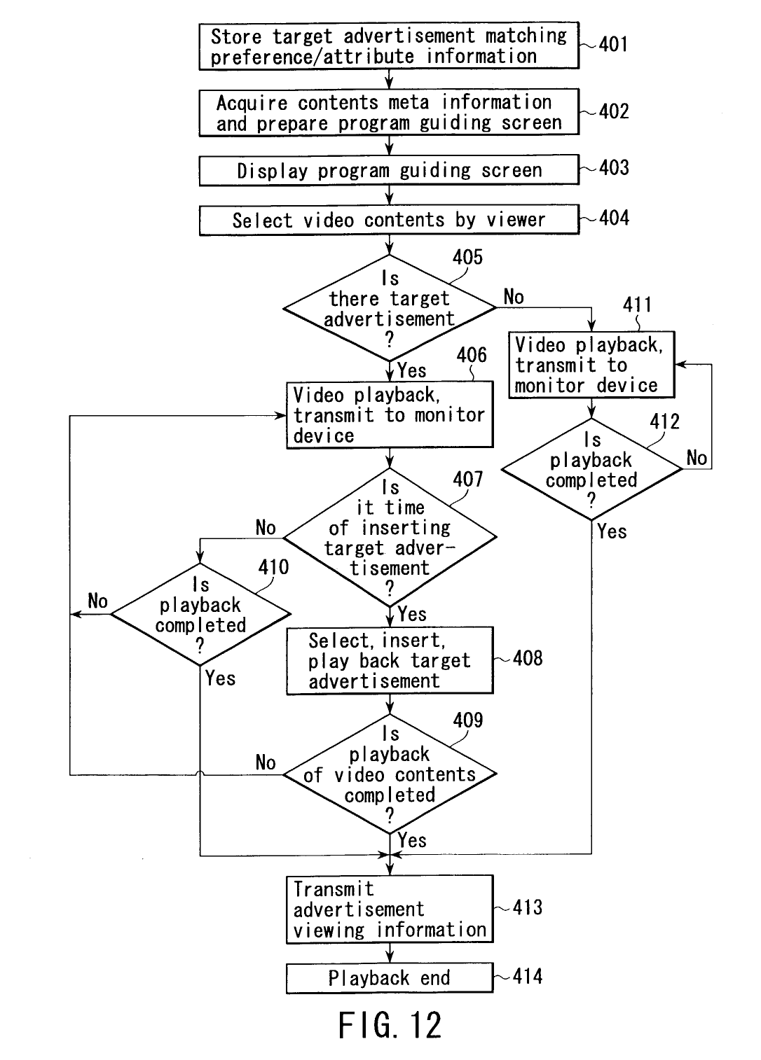

The insertion of the target advertisement is carried out in accordance with the flow shown in FIG. 12. Video contents into which all three types of advertisements are inserted are transmitted to the monitor 8 by the set top box 7, and are displayed to the viewers.

First, the target advertisements matching the preference/attribute information of the viewer are stored in advance in the hard disk drive 7B of the set top box 7 from the advertising contents storing apparatus 2 and the transmitting apparatus 5 (401).

(1) In the set top box 7 which is the client side, the video playback software 7A, which is an application having the function of selecting and receiving video contents, is operated. The contents meta information of the contents meta information database 11 at the distributing side is acquired and used. A program guiding screen, for example, as shown in FIG. 13, is presented to the viewer, and the viewer is urged to select the contents (402, 403).

(2) One of these programs is selected by the viewer operating a remote control device or the like (404).

(3) The video playback software 7A reads the information of the advertising contents to be inserted from among the contents meta information of the selected video contents, and determines whether there is a point at which the target advertisement is to be inserted (405).

(4) The video playback software 7A starts video playback. If the inserting point of the target advertisement exists, at that position, the video playback software 7A selects the target advertisement from among the target advertisements for the viewer which have been stored, and inserts and plays back the target advertisement (406 to 412).

As the method for selecting, when the twenty target advertisements described above are stored, these may be simply circulated, and it is possible to raise or lower the proportion of the advertising contents among the twenty target advertisements displayed at the time of circulating, in accordance with the importance degree rank of the target advertisement.

(5) The video playback software 7A transmits the information of the advertising contents viewed during receiving and playing-back given video contents, to the advertising contents distributing management apparatus 4 at the point in time of ending the viewing of the contents, and the playback is completed (413, 414). Here, the information to be transmitted are the content ID of the video contents and the viewer ID.

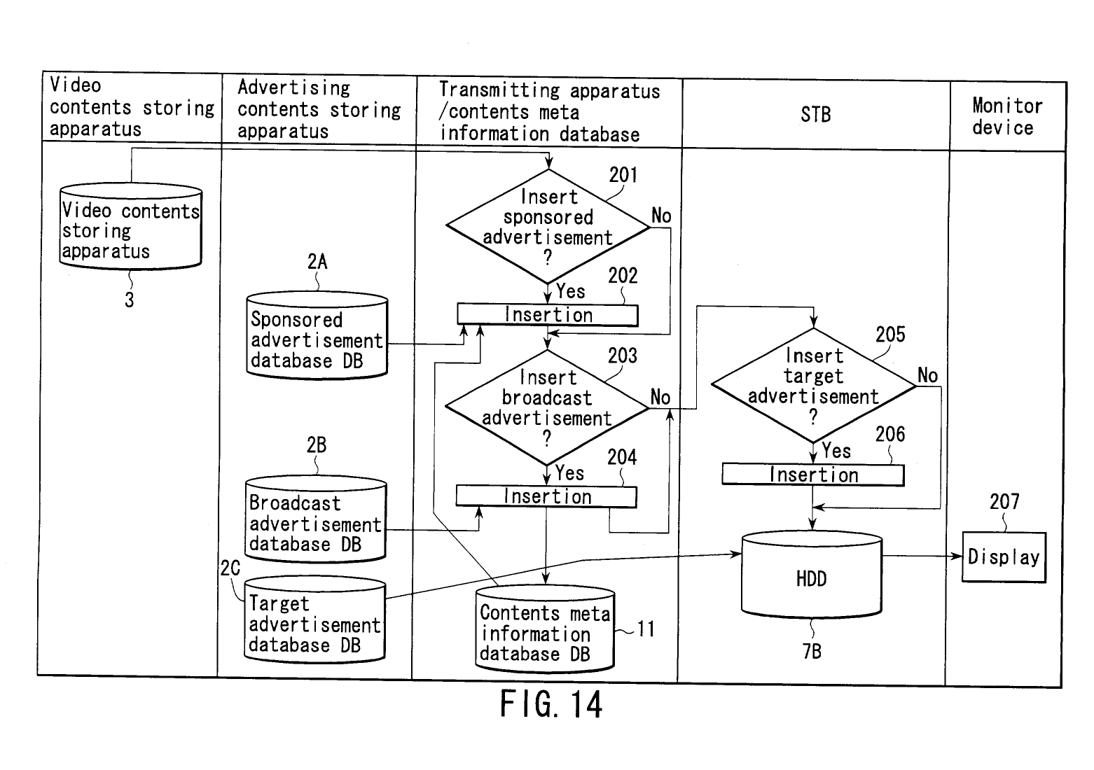

Next, operation of the first usage at the distributing side and the viewing side of the video contents in the distributing system in the present embodiment will be described with reference to FIG. 14.

First, the video contents are stored in the video contents storing apparatus 3 at the distributing side. There are a sponsored advertising contents database 2A, a broadcast advertising contents database 2B, and a target advertising contents database 2C in the advertising contents storing apparatus 2. The sponsored advertising contents are stored in the sponsored advertising contents database 2A, and the broadcast advertising contents are stored in the broadcast advertising contents database 2B, and the target advertising contents are stored in the target advertising contents database 2C.

Note that the target advertising contents corresponding to the preference/attribute information of the viewer are transmitted in advance to the hard disk drive 7B of the set top box 7 for each viewer from the target advertising contents storing apparatus 2, and are maintained therein.

The video contents from the video contents storing apparatus 3 and the sponsored advertising contents from the sponsored advertising contents database 2A of the advertising contents storing apparatus 2 are fetched into the transmitting apparatus 5. The sponsored advertising contents are inserted/de-inserted into the video contents in accordance with the contents meta information of the contents meta information database 11 (201, 202).

Next, the video contents into which the sponsored advertising contents are inserted/de-inserted, and the broadcast advertising contents from the broadcast advertising contents database 2B of the advertising contents storing apparatus 2 are fetched into the transmitting apparatus 5, and the broadcast advertising contents are inserted/de-inserted into the video contents in accordance with the contents meta information of the contents meta information database 11 (203, 204).

At the transmitting apparatus 5, the video contents and/or the broadcast advertising contents, into which the sponsored advertising contents are inserted/de-inserted, enter the set top box 7 via the distributing infrastructure 6.

In the set top box 7, the target advertising contents corresponding to the preference/attribute information of the viewer, which have been maintained in advance in the hard disk drive 7B of the set top box 7, are inserted/de-inserted into the video contents in which the sponsored advertising contents and/or the broadcast advertising contents are inserted/de-inserted, in accordance with the contents meta information of the contents meta information database 11, and are presented to be displayed on the monitor device 8 (205, 206, 207).

(Operation of Replacing Advertising Contents at the Time of Reusing Contents)

In the above-description, the advertisement inserting method according to the system of the first usage such that the contents are acquired from the distributing system has been described.

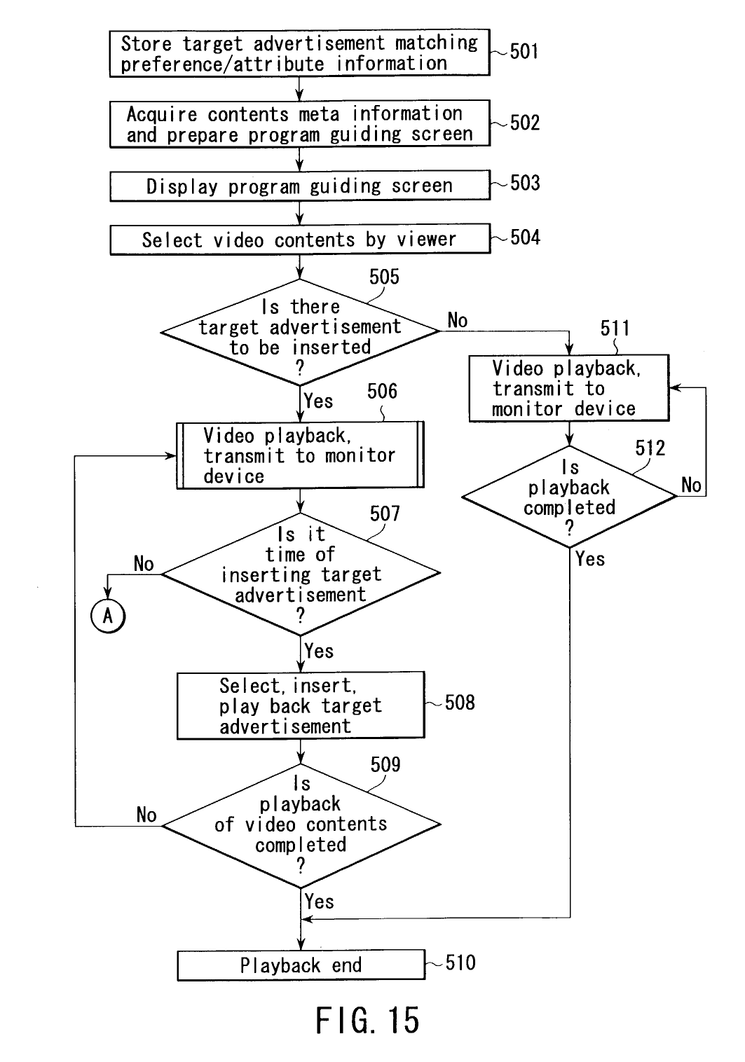

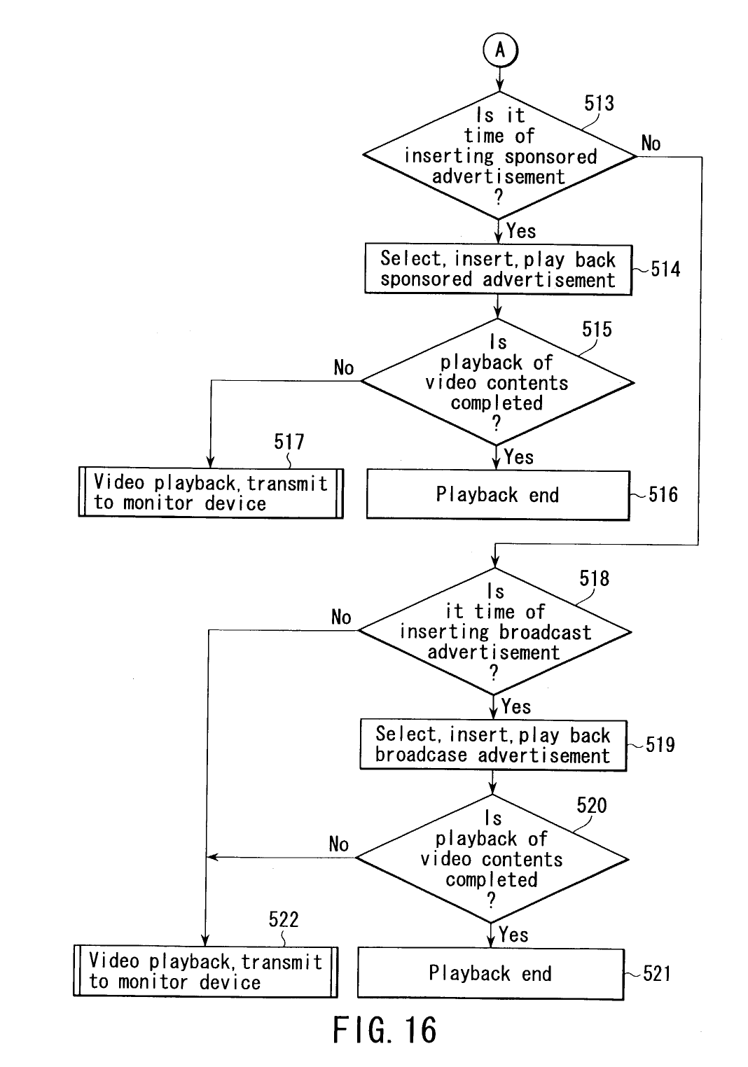

Next, with respect to the replacement of the advertising contents in a case in which the contents are secondarily used after the video contents received in the above-described way are stored and recorded at the distributing side, operation of the set top box 7 which is the client side will be described with reference to FIG. 15 and FIG. 16.

In the present embodiment, after the first usage, the video contents in which the sponsored advertisement and the broadcast advertisement have been inserted are stored in the hard disk drive 7B of the set top box 7 (501).

Further, when movement or copying of the video contents arises, the contents meta information of the video contents is newly acquired from the contents meta information database 11 by using the content ID acquired from the beginning of the movement by the video playback software 7A of the set top box 7 at the movement destination, and advertising contents according to the meta information are inserted at the time of playback.

If the information of the advertising contents registered in the contents meta information has changed, the previous sponsored advertisement and broadcast advertisement which are recorded can be replaced. With respect to the target advertisement, a target advertisement matching the viewer at the movement destination can be inserted by processing in the same way as in accordance with the flow described above. The sponsored advertisement and the broadcast advertisement are replaced and inserted as follows.

(1) The contents meta information of the moved video contents is acquired (502). A program guiding screen as shown in FIG. 13 is displayed by the contents meta information, and the viewer selects the video contents by a remote control device or the like (503, 504).

(2) The respective content IDs of the sponsored advertisement, the broadcast advertisement, and the target advertising contents which must be inserted into the video contents are acquired from the contents meta information.

(3) When it is determined that it is the time for inserting the target contents on the basis of the content ID of the target advertisement of the contents meta information, the set top box 7 requests the target advertising contents, and requests the target advertising contents to the advertising contents distributing management apparatus 2, and receives and stores the target advertising contents. The target advertising contents are inserted at an appropriate inserting position during the time the video contents are being played back, and are displayed on the monitor device 8 (505 through 512).

(4) Next, when it is determined that it is not the time for inserting the target contents, the set top box 7 requests the sponsored advertising contents and receives and stores the sponsored advertising contents, when it is determined that it is the time for inserting the sponsored contents on the basis of the content ID of the sponsored advertisement of the contents meta information. The sponsored advertising contents are inserted at an appropriate inserting position during the time the video contents are being played back, and are displayed on the monitor device 8 (505 through 512).

(5) When it is determined that it is not the time for inserting the sponsored contents, the set top box 7 requests the broadcast advertising contents and receives and stores the broadcast advertising contents, when it is determined that it is the time for inserting the broadcast contents on the basis of the content ID of the broadcast advertisement of the contents meta information. The broadcast advertising contents are inserted at an appropriate inserting position during the time the video contents are being played back, and are displayed on the monitor device 8 (518 through 522).

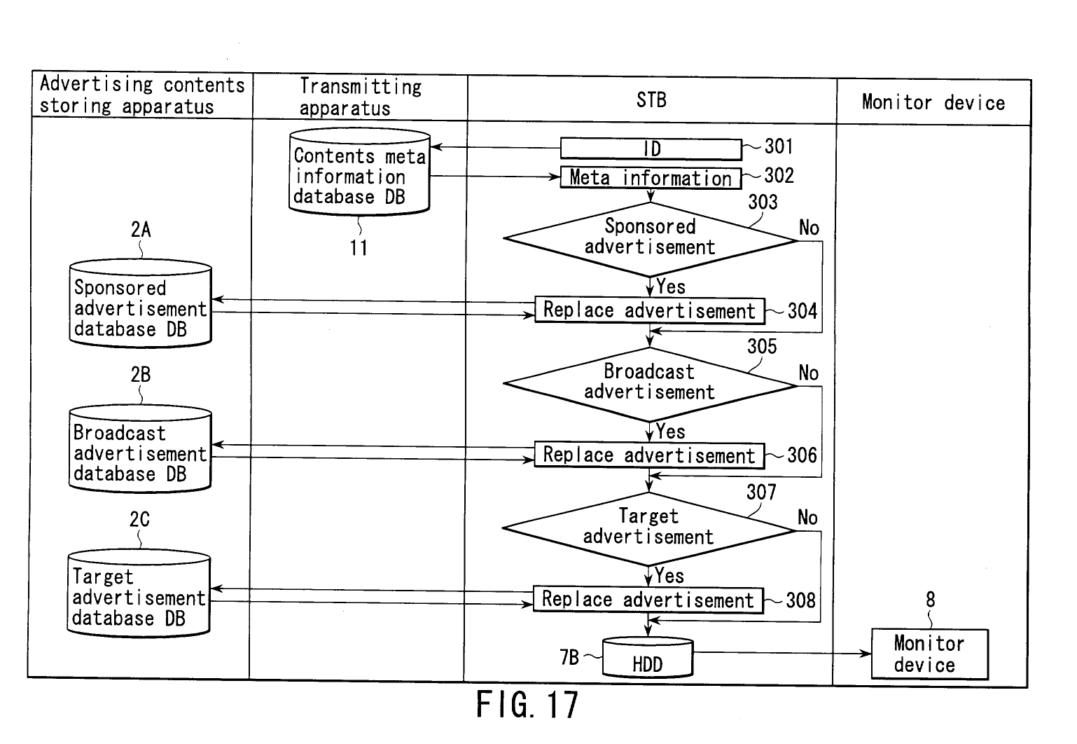

Next, operations of secondary usage at the distributing side and the viewing side of the video contents in the distributing system of the present invention will be described with reference to FIG. 17.

First, as shown in FIG. 17, the video contents are stored in the video contents storing apparatus 3 at the distributing side. There are the sponsored advertising contents database 2A, the broadcast advertising contents database 2B, and the target advertising contents database 2C in the advertising contents storing apparatus 2. The sponsored advertising contents are stored in the sponsored advertising contents database 2A, and the broadcast advertising contents are stored in the broadcast advertising contents database 2B, and the target advertising contents are stored in the target advertising contents database 2C.

Note that the target advertising contents corresponding to the preference/attribute information of the viewer are transmitted in advance to the hard disk drive 7B of the set top box 7 for each viewer from the target advertising contents storing apparatus 2, and are maintained therein. Further, the video contents, which have been firstly used by that set top box 7 or others and into which the advertising contents have been inserted, are maintained in the hard disk drive 7B.

When the video contents maintained in the hard disk drive 7B are secondarily used by the video playback software 7A of the set top box 7, the content ID is newly acquired from the contents meta information database 11 (301, 302).

Next, in the set top box 7, the sponsored advertising contents are fetched from the sponsored advertising contents database 2A of the advertising contents storing apparatus 2 in accordance with the content ID, and the sponsored advertising contents are inserted/replaced into the video contents (303, 304).

Subsequently, in the set top box 7, the broadcast advertising contents are fetched into in the set top box 7 from the broadcast advertising contents database 2B of the advertising contents storing apparatus 2 in accordance with the content ID, and the broadcast advertising contents are inserted/replaced into the video contents (305, 306).

Next, in the set top box 7, the target advertising contents are fetched into the set top box 7 from the advertising contents database 2C of the advertising contents storing apparatus 2 in accordance with the content ID, and the broadcast advertising contents are inserted/replaced into the video contents, and are provided for display on the monitor device 8 (307, 308).

In accordance with the operations described above, by changing the registered information relating to the inserted advertising contents of the contents meta information of the video contents in accordance with the intentions of the contents provider, the sponsor, and the distributor, the sponsored advertisement and the broadcast advertisement which are inserted can be replaced at the time of secondary usage of the video contents. Further, the target advertisement can be replaced with a target advertisement matching the preference information and the attribute information of the viewer at the movement destination, and an improvement in the effects of advertising can be attempted.

In the above description, the advertising contents storing apparatus 2, the video contents storing apparatus 3, the advertising contents distributing management apparatus 4, the transmitting apparatus 5, and the contents meta information database 11 which are the transmitting side are newly structured as independent apparatuses. In addition thereto, existing computers or servers can be utilized.

Further, one portion or the entirety of the advertising contents storing apparatus 2, the video contents storing apparatus 3, the advertising contents distributing management apparatus 4, the transmitting apparatus 5, and the contents meta information database 11 can be structured by a method or a program as one computer or a plurality of computers, or the hardware or software functions of one portion of these computers. This program is stored in a computer readable medium.

As described above, in accordance with the present invention, an advertisement inserting method, a distributing system, a transmitting apparatus, a receiving apparatus, and a program in which sponsors, contents providers, content distributors, and viewers can respectively have more merits can be provided.

What is claimed is:

1. An advertisement inserting method which is applied to a system in which a distributing side has at least a storing apparatus configured to store video contents and advertising contents and a transmitting apparatus, and a viewing side has at least a viewing apparatus configured to view the video contents in which the advertising contents are inserted, the method inserting the advertising contents into the video contents,
wherein the video contents and the advertising contents are respectively and independently managed at the distributing side, and the advertising contents are selectively inserted into the video contents at the distributing side and the viewing side.

2. An advertisement inserting method according to claim 1, wherein the distributing side has a holding unit configured to hold contents meta information showing an outline of the video contents, and the viewing side has a holding unit configured to hold the advertising contents, and
at the viewing side, the advertising contents are inserted into the video contents by referring to the contents meta information with respect to the distributing side.

3. An advertisement inserting method according to claim 2, wherein the viewing side replaces the advertising contents by referring to the contents meta information with respect to the distributing side.

4. An advertisement inserting method according to claim 3, wherein the viewing side downloads the advertising contents with respect to the viewing side from the distributing side by referring to the contents meta information at the distributing side, and the downloaded advertising contents are replaced and inserted into the video contents.

5. An advertisement inserting method according to claim 1, wherein the distributing side classifies and manages the advertising contents by making at least one of preference information and attribute information of the viewing side and a range of advertising be a numeric value in a form of a preference degree.

6. An advertisement inserting method according to claim 1, wherein the distributing side classifies the advertising contents into a sponsored advertisement relating to the video contents, a broadcast advertisement relating to a distributing form, and a target advertisement relating to the viewing side, and manages them, and
the sponsored advertisement and the broadcast advertisement are inserted into the video contents at the distributing side, and the target advertisement is inserted into the video contents at the viewing side.

7. A distributing system comprising:
a transmitting apparatus comprising a classification managing unit configured to individually manage video contents and advertising contents and to classify and manage the advertising contents at least on the basis of characteristics which do not relate to characteristics of a viewing side and characteristics which relate to characteristics of the viewing side, a transmitting unit configured to transmit the advertising contents classified on the basis of the characteristics which relate to the characteristics of the viewing side to the viewing side so as to be inserted in the video contents at the viewing side, and to insert the advertising contents classified on the basis of the characteristics which do not relate to the characteristics of the viewing side into the video contents so as to transmit them to the viewing side, and a transmitting side holding unit configured to hold contents meta information showing an outline of the video contents; and
a receiving apparatus comprising a receiving side holding unit configured to hold the advertising contents classified on the basis of the characteristics which relate to the characteristics of the viewing side, and an interposing unit configured to make at least one of the advertising contents of the holding unit and advertising contents downloaded from the distributing side be interposed into the video contents with reference to the contents meta information.

8. A transmitting apparatus comprising:
a classifying managing unit configured to individually manage video contents and advertising contents, and to classify and manage the advertising contents at least on the basis of characteristics which do not relate to characteristics of a viewing side and characteristics which relate to characteristics of the viewing side; and
a transmitting unit configured to transmit the advertising contents classified on the basis of the characteristics which relate to the characteristics of the viewing side to the viewing side so as to be inserted in the video contents at the viewing side, and to insert the advertising contents classified on the basis of the characteristics which do not relate to the characteristics of the viewing side into the video contents so as to transmit them to the viewing side.

9. A transmitting apparatus according to claim 8, further comprising:
a holding unit configured to hold contents meta information showing an outline of the video contents; and
a transmitting unit configured to transmit to the viewing side advertising contents insertion conditions corresponding to the video contents by referring to the contents meta information from the viewing side.

10. A transmitting program stored in a computer readable medium configured to distribute video contents into which advertising contents are inserted to a viewing side, the transmitting program comprising:
individually managing video contents and advertising contents, and classifying and managing the advertising contents at least on the basis of characteristics which do not relate to characteristics of the viewing side and characteristics which relate to the characteristics of the viewing side;
transmitting the advertising contents classified on the basis of the characteristics which relate to the characteristics of the viewing side to the viewing side so as to be inserted into the video contents at the viewing side;
inserting the advertising contents classified on the basis of the characteristics which do not relate to the characteristics of the viewing side into the video contents, and transmitting them it to the viewing side;
holding contents meta information showing an outline of the video contents; and
transmitting to the viewing side advertising contents insertion conditions corresponding to the video contents by referring to the contents meta information from the viewing side.

11. A receiving apparatus receiving, from a distributing side, video contents into which advertising contents to be displayed on a display device are inserted, comprising:
a holding unit configured to hold the advertising contents; and
an interposing unit configured to make at least one of the advertising contents of the holding unit and advertising contents downloaded from the distributing side be interposed into the video contents, with reference to contents meta information showing an outline of the video contents provided at the distributing side.

12. A receiving program stored in a computer readable medium having a function of receiving, from a distributing side, video contents into which advertising contents to be displayed on a display device are inserted, the receiving program comprising:
holding advertising contents; and
making at least one of the held advertising contents and advertising contents downloaded from the distributing side be interposed into the video contents, with reference to contents meta information showing an outline of the video contents provided at the distributing side.
